(19) United States
(12) Patent Application Publication
(10) Pub. No.: US 2002/0075302 A1
(43) Pub. Date: Jun. 20, 2002

(54) Method of displaying hypertext based on a prominence rating

(75) Inventor: Andrew D. Simchik, San Bruno, CA (US)

Correspondence Address: Albert P. Sharpe, III, Esq., Fay, Sharpe, Fagan, Minnich & McKee, LLP, 7th Floor, 1100 Superior Avenue, Cleveland, OH, 44114-2518, US

(73) Assignee: XEROX CORPORATION

(21) Appl. No.: 09/737,535

(22) Filed: Dec. 15, 2000

(51) Int. Cl. G09G 5/00

(52) U.S. Cl. 345/745

(57) ABSTRACT

A method of displaying hypertext is disclosed. The method includes tracking a hypertext access to a document and assigning a prominence rating to the hypertext based on the tracking, wherein the prominence rating is based on frequency of access by a user, and on recency of access by the user. A visual cue of the hypertext is changed on a display according to the prominence rating. An apparatus for displaying hypertext is also disclosed.

### BACKGROUND OF THE INVENTION

1. Field of the Invention

The invention pertains to the art of organizing graphical representations of computer links and, more particularly, to a scheme for altering the visual appearance of hypertext in such a manner as to reflect recency and frequency of use of the hypertext.

2. Description of Related Art

When one computer connects to one or more other computers, the user of the computer often accesses information on the other computers. One method of providing such access is through the use of hypertext. Hypertext is text that contains hyperlinks. Hyperlinks are devices used in computers which provide access to documents based on Hypertext Markup Language (‘HTML’) that are located in other computers or other areas.

For users who visit other computer locations frequently, a method of organizing hypertext is beneficial, because multiple links are often present while only few are used. Changing the color of a previously accessed hypertext link is well known in the art, but a user is still unable to determine which link was most frequently used. U.S. Pat. No. 5,446,891 teaches the organization of hypertext in a prioritized list according to frequency of use. At the highest priority is the most frequently used link, with the rest of the links following according to decreasing amount of use. U.S. Pat. No. 6,069,625 describes spatial separation of elements on a graphical interface according to frequency of use. Essentially, most frequently accessed elements are placed in one area on the display screen of the computer, while less frequently accessed elements are placed in a separate area.

The present invention contemplates a new method for displaying hypertext for a computer user. The method is based upon a prominence rating which is assigned according to both frequency of use and recency of use of the hypertext, for which parameters can be adjusted by an administrator or a user. Furthermore, the resulting display of hypertext utilizes visual cues which go beyond a priority list or spatial separation.

### SUMMARY OF THE INVENTION

In accordance with one embodiment of the present invention, a method of displaying hypertext is disclosed. The method includes tracking a hypertext access to a document and assigning a prominence rating to the hypertext based on the tracking, wherein the prominence rating is based on frequency of access by a user, and on recency of access by the user. A visual cue of the hypertext is changed on a display according to the prominence rating.

In accordance with another embodiment of the present invention, a method of displaying hypertext is disclosed. The method includes accessing a set of data stored on a local memory by an Internet server and interpreting the set of data. A prominence rating is assigned to hypertext based on the set of data, wherein the prominence rating is based on frequency of access by a user as shown by the set of data, and on recency of access by the user as shown by the set of data. A visual cue of the hypertext is changed on a display according to the prominence rating.

In accordance with another embodiment of the present invention, an apparatus for displaying hypertext is disclosed.

One advantage of the present invention is that because the prominence rating is based in part on recency of access to a link, current, up-to-date activities are factored in the alteration of the display of the hypertext, thus providing the user with better information which allows the user to be more efficient.

Another advantage of the present invention is that because the prominence rating can be divided into categories, sophisticated groupings in the display of hypertext may be accomplished, providing the user with a more advantageous set-up than a simple priority list, increasing the user's efficiency.

Yet another advantage of the present invention is that the user or a system administrator may control the prominence rating parameters, allowing the user to configure the settings for which hypertext is adjusted, thus creating a flexible and more friendly user interface.

Still another advantage of the present invention is that the hypertext may be adjusted according to many different visual cues instead of only simple priority listing or spatial separation, allowing easier recognition by a user and increasing the user's efficiency.

Still another advantage of the present invention is that the user or a system administrator may control which visual cues are utilized, providing for a more custom-style setup and thus creating a more flexible and friendly user interface.

Still further advantages of the present invention will become apparent to those of ordinary skill in the art upon reading and understanding the following detailed description of the preferred embodiments.

### BRIEF DESCRIPTION OF THE DRAWINGS

The invention may take form in various components and arrangement of components, and in various steps and arrangements of steps. The drawings are only for purposes of illustrating the preferred embodiments and are not to be construed as limiting the invention.

FIG. 1 is a block diagram illustration of a system which utilizes the current invention;

FIG. 2 is a depiction of a computer screen display of the prior art;

FIG. 3 is a flow chart illustrating the steps of one embodiment of the current invention.

FIG. 4 is a depiction of the resulting display of one embodiment of the current invention;

FIG. 5 is a depiction of the resulting display of another embodiment of the current invention;

FIG. 6 is a depiction of the resulting display of yet another embodiment of the current invention;

FIG. 7 is a depiction of a prior art computer screen display;

FIG. 8 is a depiction of the resulting display of still another embodiment of the current invention;

FIG. 9 is a block diagram illustration of another system which utilizes the current invention; and

FIG. 10 is a block diagram illustration of yet another system which utilizes the current invention.

### DETAILED DESCRIPTION OF THE PREFERRED EMBODIMENT

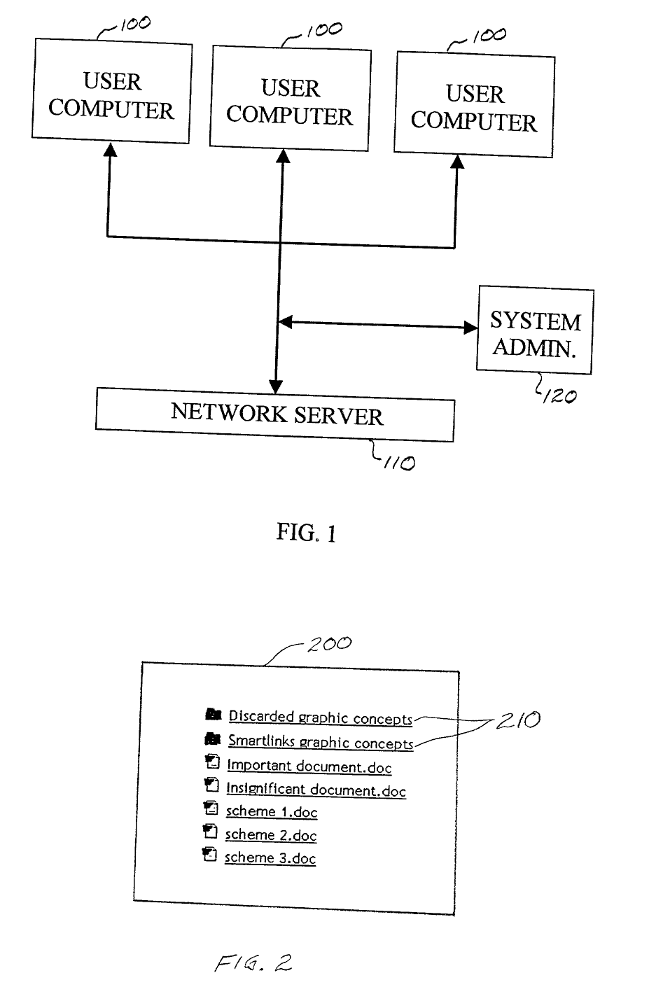

With reference to FIG. 1, a block diagram illustration of an exemplary computer network or system which utilizes the current invention is shown. When user computers 100 are connected or otherwise networked together, they are often done so in different ways and for different purposes. An example of one method of connection is a multiplicity of user computers 100 connected to a network server 110. A system administrator 120 typically controls many of the system settings and parameters. When user computers 100 are connected, the users often share documents, pictures, charts, graphs, timelines and other graphics through a document sharing system such as DocuShare by Xerox Corporation.

In order to facilitate the sharing of documents and other items between user computers 100, hypertext is often utilized. Hypertext is text which denotes a certain document or item and contains a hyperlink to that item. A hyperlink is the programming device which allows one computer user 100 to retrieve the desired document or item from the network server 110.

Turning now to FIG. 2, a depiction of a computer screen display of the prior art 200, most users are faced with many hyperlinks 210 on a single computer display screen. However, a user will typically only access a few hyperlinks of those listed. As a result, it can become time consuming for a user to search for a desired hyperlink on a frequently used computer screen display 200.

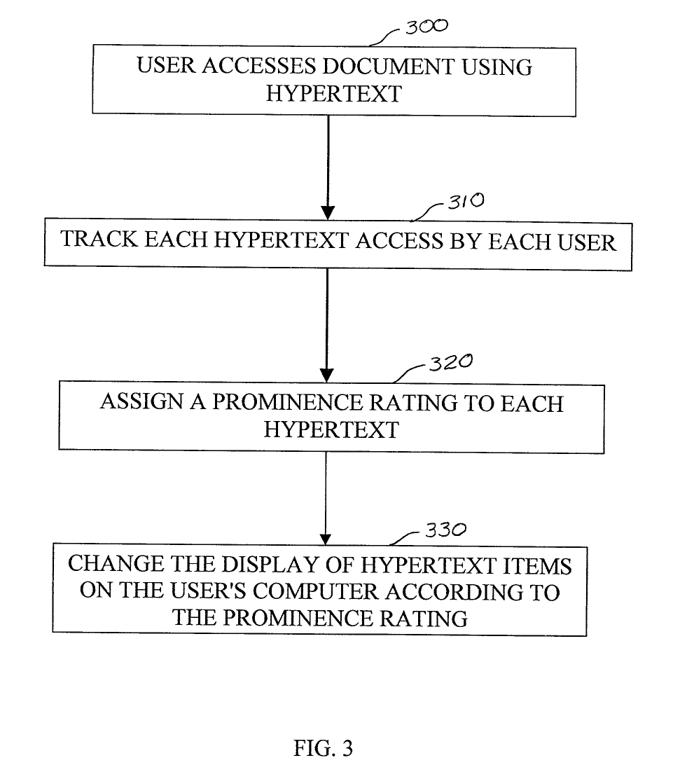

With reference to FIG. 3, the steps of one embodiment of the current invention are illustrated. A user on a user computer 100 (FIG. 1) accesses a document or other item using hypertext, step 300. Each access of an item through hypertext is tracked, step 310. A prominence rating is assigned to each hypertext link based upon the tracking, step 320. Tracking is accomplished in a conventional manner. For example, it is well known in the art how to track recency of access, as embodied in typical word processing software. In addition, several prior art patents disclose techniques for tracking frequency of access. The display of the hypertext is changed on the user computer 100 according to the prominence rating, step 330. The prominence rating is based both on frequency of access of the hyperlink by the user and recency of access. Any known technique may be used to assign the rating. For example, a look-up table containing a count of frequency of access of each link, a corresponding date of most recent access and the resulting prominence rating may be used. The user or a system administrator can control these parameters, thus allowing a customized measurement. One embodiment of the invention provides for tracking of access of hypertext as mentioned above by a single user, thus allowing customization according to that user's most frequently and recently accessed links. Another embodiment of the invention provides for tracking of hypertext access by multiple users, typically by a system administration function. In that embodiment, the prominence rating is based upon frequency and recency of access by the entire group of users, thus allowing a display customized to the requirements of the group. Yet another embodiment provides for tracking of access of hypertext by individual users in a multiple computer system, typically by a system administration function. There, a prominence rating is based upon frequency and recency of access by each user, allowing a display to be customized to each individual user within the group.

The current invention also provides for different visual cues based upon different levels of the prominence rating. For example, hypertext which has been accessed frequently and recently may be displayed differently than hypertext which has been accessed frequently but not recently. Likewise, hypertext which has been accessed recently but not frequently may be displayed differently, while a different visual cue may also be used for links not frequently or recently accessed. In addition, different levels of frequency within the same designated recency period may be displayed differently. Because the user or the system administrator can specify the parameters for periods of time to decide recency and groups of frequency of access, a sophisticated display of altered hypertext can be created.

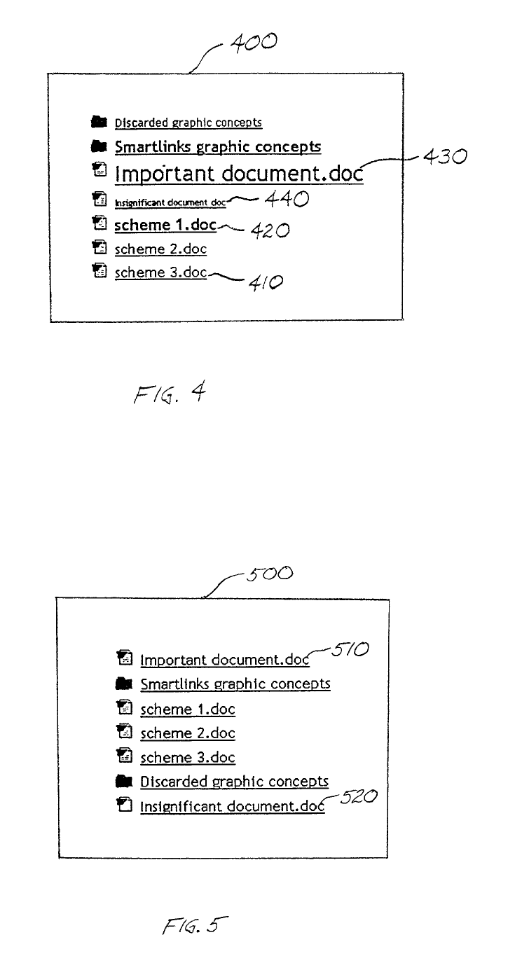

Turning now to FIG. 4, a depiction of the resulting display 400 of one embodiment of the current invention is shown. A typical hyperlink font style and size 410 may be a part of the resulting display 400. In this embodiment, hypertext with a higher prominence rating 420 than a hyperlink of the standard type 410 is visually cued by bold typeface. Hypertext with an even higher prominence rating 430 has an increased font size. A link with the lowest prominence rating 440 is shown in a decreased font size. Thus, the visual cue may consist of changing the font size, font style, color, boldness, underlining, spatial separation or prioritization of the hypertext as well as a combination of these changes.

With reference to FIG. 5, the current invention may display hypertext visually cued to priority based on prominence rating which is based on frequency and recency of access 500. In this embodiment, the hypertext with the highest prominence rating 510 is placed first in the display list and the other links are displayed according to decreasing prominence rating, with the hypertext of lowest prominence rating 520 last.

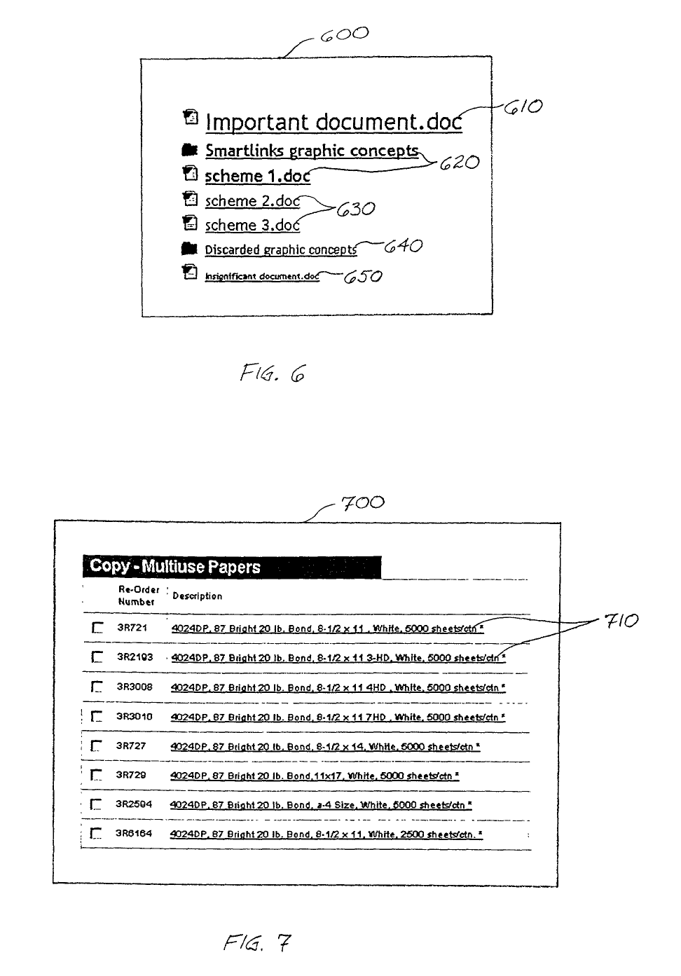

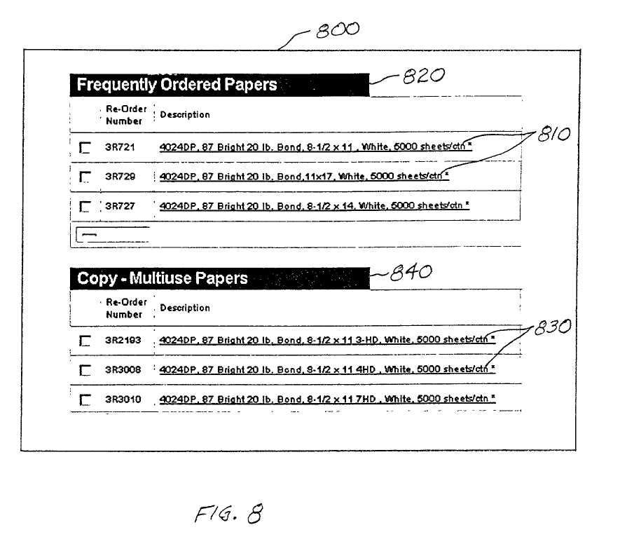

FIG. 6 shows a display screen 600 resulting from a combination of visual cues, including font changes and prioritization of hypertext. The hypertext with the highest prominence rating 610 is the first in a list of links and its font size has been increased. Hypertext that is in a lower category of prominence ratings 620 is next in the list and has been bolded. Links that are in a yet lower prominence rating category 630 are shown next in the list in a typical font size and boldness. Hypertext that is assigned prominence ratings of still lower categories 640, 650 is displayed at the end of the list in decreasing font sizes. As a result, a user can quickly discern between hypertext which is accessed more recently and frequently and that which is not.

Turning now to FIG. 7, a display of the prior art 700 is depicted. Many hypertext items 710 are shown in a list pre-determined by someone other than the computer user or system administrator, creating the need for the user to tediously visually sort through the list.

This problem is solved with the embodiment of the invention shown in FIG. 8. A screen display 800 incorporating a visual cue of spatial separation which is dictated by a prominence rating based on recency and frequency of access eliminates the need for a user to sort through a long list of hypertext. Hypertext in the highest category of prominence rating 810 is placed in one section with a corresponding heading 820. Hypertext in a lower category of prominence rating 830 is placed in another section of the display with a separate heading 840.

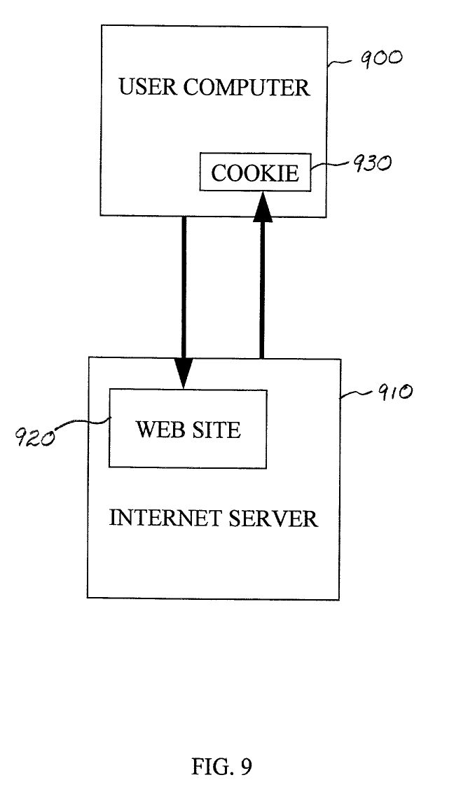

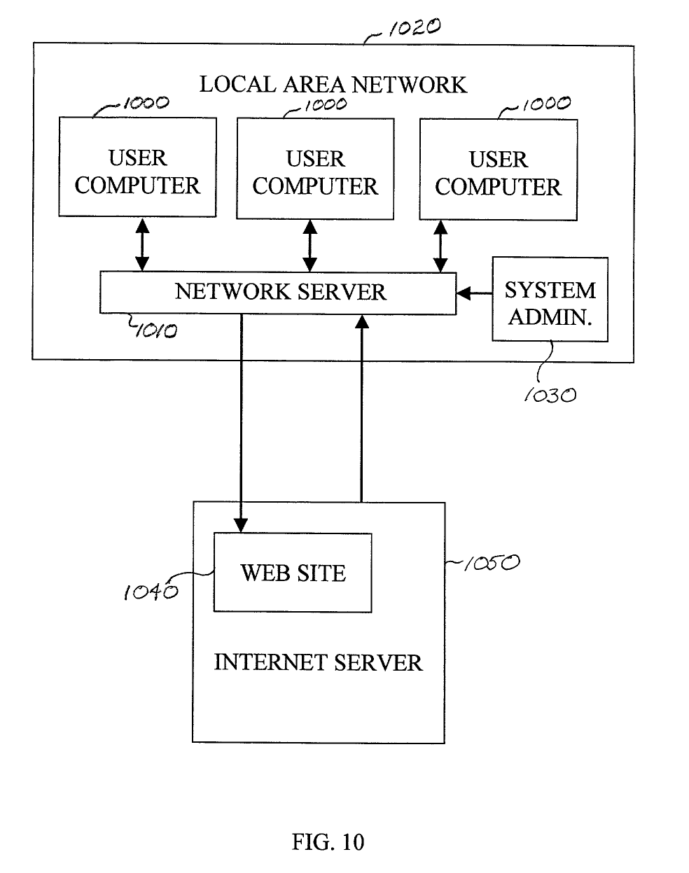

The current invention may also be incorporated into a computer system utilizing the Internet. As FIG. 9 illustrates, a user computer 900 contacts an Internet server 910 to gain access to a web site 920 using hypertext. The Internet server 910 typically stores a set of data on a local memory, commonly referred to as a cookie 930, on the user computer 900. The cookie 930 often contains information deposited each time a web site 920 is accessed, including the date and time of each access. Thus, a calculation of the frequency and recency of access of the web site 920 through the use of the hypertext, similar to the previously described embodiments, is possible. As mentioned above, tracking of frequency and recency may be accomplished in a conventional manner and any known technique may be used to generate and assign the rating. For example, to generate the rating, a look-up table containing a count of frequency of access of each link, a corresponding date of most recent access and the resulting prominence rating may be used. Internet server 910 can access the cookie 930 on subsequent visits by the user to the web site 920, interpret the data 930 and assign from the data a prominence rating based on frequency and recency of access to the hypertext. The subsequent display of the hypertext on the user computer 900 can then be altered by changing visual cues according to the prominence rating as described in the previous embodiments. It is anticipated for a web browser to be configured to interpret the data in addition to the internet server 910, thus allowing control of the frequency and recency parameters by either the Internet server administrator or the computer user, or both.

Turning finally to FIG. 10, an embodiment of a multiple user computer system utilizing the current invention in regard to the Internet is shown. A multiplicity of user computers 1000 is connected to a network server 1010 to form a local area network 1020. A system administrator 1030 typically retains control over the server 1010 and system settings. When a user computer 1000 accesses a web site 1040, the communication is instigated through a hypertext link and may pass through the network server 1010 as shown or may bypass the network server 1010. Once the web site 1040 is accessed, Internet server 1050 contacts the network server 1010 or user computer 1000, depending on the configuration of the system. The access of a cookie, resultant calculation and assignment of a prominence rating to the hypertext, along with the change of visual cues on the display of the hypertext according to the prominence rating, is essentially the same as described above for FIG. 9. The basic difference for the purpose of the current invention in regard to FIG. 10 is that the cookie may be located on or be under the control of the local area network server 1010 instead of the user computer 1000. As a result, the system administrator 1030 may control the frequency and recency parameters instead of the Internet server administrator or the computer user. As described in the above embodiments, the prominence rating may be based upon the frequency and recency of access of the entire group of users or upon each individual user, thus allowing a display to be customized to the requirements of the group or to the requirements of each individual user.

Another embodiment of the current invention includes a computer apparatus for displaying hypertext based on a prominence rating. The apparatus includes typical system hardware, such as a display and a processor which is connected to the display. A computer program, also known as software, operates on the processor and contains at least one program module to track a hypertext access to a document as described in the prior embodiments. The software also includes a module which assigns a prominence rating to the hypertext based on the tracking, wherein the prominence rating is based on frequency of access by a user and on recency of access by the user. Another module operates to change a visual cue of the hypertext on a display according to the prominence rating.

The software may also be configured to operate on a computer which will connect to the Internet. In such an embodiment, the software includes a module to program the processor to access a set of data stored on a local memory by an Internet server. The software has a module to interpret the set of data and assign a prominence rating to hypertext based on the set of data, wherein the prominence rating is based on frequency of access by a user as shown by the set of data and on recency of access by the user as shown by the set of data. As described above, another module operates to change a visual cue of the hypertext on a display according to the prominence rating.

The invention has been described with reference to the preferred embodiments. Potential modifications and alterations will occur to others upon a reading and understanding of the specification. It is our intention to include all such modifications and alterations insofar as they come within the scope of the appended claims, or the equivalents thereof

What is claimed is:

1. A method of displaying hypertext, comprising the steps of:
tracking a hypertext access to a document;
assigning a prominence rating to the hypertext based on the tracking, wherein the prominence rating is based on frequency of access by a user, and on recency of access by the user; and
changing a visual cue of the hypertext on a display according to the prominence rating.

2. A method of displaying hypertext according to claim 1, wherein the step of changing a visual cue of the hypertext on a display includes changing a font size of the hypertext.

3. A method of displaying hypertext according to claim 1, wherein the step of changing a visual cue of the hypertext on a display includes changing a font style of the hypertext.

4. A method of displaying hypertext according to claim 1, wherein the step of changing a visual cue of the hypertext on a display includes changing a color of the hypertext.

5. A method of displaying hypertext according to claim 1, wherein the step of changing a visual cue of the hypertext on a display includes changing a boldness of the hypertext.

6. A method of displaying hypertext according to claim 1, wherein the step of changing a visual cue of the hypertext on a display includes changing an underline of the hypertext.

7. A method of displaying hypertext according to claim 1, wherein the step of changing a visual cue of the hypertext on a display includes changing an order of the hypertext in a list.

8. A method of displaying hypertext according to claim 1, wherein the step of changing a visual cue of the hypertext on a display includes changing a spatial separation of the hypertext.

9. A method of displaying hypertext, comprising the steps of:
accessing a set of data stored on a local memory by an Internet server;
interpreting the set of data;
assigning a prominence rating to hypertext based on the set of data, wherein the prominence rating is based on frequency of access by a user as shown by the set of data, and on recency of access by the user as shown by the set of data; and
changing a visual cue of the hypertext on a display according to the prominence rating.

10. A method of displaying hypertext according to claim 9, wherein the set of data stored on a local memory by the Internet server is located on a user's computer.

11. A method of displaying hypertext according to claim 9, wherein the set of data stored on a local memory by the Internet server is located on a local area network server.

12. A method of displaying hypertext according to claim 9, wherein the step of changing a visual cue of the hypertext on a display includes changing a font size of the hypertext.

13. A method of displaying hypertext according to claim 9, wherein the step of changing a visual cue of the hypertext on a display includes changing a font style of the hypertext.

14. A method of displaying hypertext according to claim 9, wherein the step of changing a visual cue of the hypertext on a display includes changing a color of the hypertext.

15. A method of displaying hypertext according to claim 9, wherein the step of changing a visual cue of the hypertext on a display includes changing a boldness of the hypertext.

16. A method of displaying hypertext according to claim 9, wherein the step of changing a visual cue of the hypertext on a display includes changing an underline of the hypertext.

17. A method of displaying hypertext according to claim 9, wherein the step of changing a visual cue of the hypertext on a display includes changing an order of the hypertext in a list.

18. A method of displaying hypertext according to claim 9, wherein the step of changing a visual cue of the hypertext on a display includes changing a spatial separation of the hypertext.

19. A computer apparatus for displaying hypertext based on a prominence rating, comprising:
a display;
a processor connected to the display; and
software means operative on the processor for:
tracking a hypertext access to a document;
assigning a prominence rating to the hypertext based on the tracking, wherein the prominence rating is based on frequency of access by a user, and on recency of access by the user; and
changing a visual cue of the hypertext on a display according to the prominence rating.

20. A computer apparatus for displaying hypertext according to claim 19, where the software means is further operative on the processor for:
accessing a set of data stored on a local memory by an Internet server;
interpreting the set of data; and
assigning a prominence rating to hypertext based on the set of data, wherein the prominence rating is based on frequency of access by a user as shown by the set of data, and on recency of access by the user as shown by the set of data.
